(19) United States
(12) Patent Application Publication
(10) Pub. No.: US 2022/0351073 A1
(43) Pub. Date: Nov. 3, 2022

(54) EXPLICIT ETHICAL MACHINES USING ANALOGOUS SCENARIOS TO PROVIDE OPERATIONAL GUARDRAILS

(71) Applicant: Raytheon Company, Waltham, MA (US)

(72) Inventors: Peggy Wu, Ellicott City, MD (US); Kunal Srivastava, Newington, CT (US)

(21) Appl. No.: 17/306,324

(22) Filed: May 3, 2021

(51) Int. Cl. G06N 20/00; G06N 7/00

(52) U.S. Cl. CPC G06N 20/00; G06N 7/005

(57) ABSTRACT

An apparatus includes at least one memory configured to store information associated with a current scenario to be evaluated by an ML/AI algorithm, where the information includes an initial reward function associated with the current scenario. The apparatus also includes at least one processor configured to (i) identify one or more policies associated with one or more prior scenarios that are analogous to the current scenario, (ii) determine one or more differences between parameters that are optimized by the initial reward function and by one or more reward functions associated with the one or more prior scenarios, (iii) modify the initial reward function based on at least one of the one or more determined differences to generate a new reward function, and (iv) generate a new policy for the current scenario based on the new reward function.

### TECHNICAL FIELD

This disclosure is generally directed to machine learning (ML) systems and other artificial intelligence (AI) systems. More specifically, this disclosure is directed to explicit ethical machines that use analogous scenarios to provide operational guardrails.

### BACKGROUND

With the increasing adoption of autonomous and semi-autonomous decision-making algorithms in various domains, it is common for the algorithms to encounter scenarios with ethical dilemmas. One example of an ethical dilemma is often referred to as the “trolley problem,” which generally considers a hypothetical situation in which a runaway trolley is heading towards multiple people on one track but can be diverted onto a different track occupied by a single person.

### SUMMARY

This disclosure relates to explicit ethical machines that use analogous scenarios to provide operational guardrails.

In a first embodiment, a method includes obtaining, using at least one processor, information associated with a current scenario to be evaluated by a machine learning/artificial intelligence (ML/AI) algorithm, where the information includes an initial reward function associated with the current scenario. The method also includes identifying, using the at least one processor, one or more policies associated with one or more prior scenarios that are analogous to the current scenario. The method further includes determining, using the at least one processor, one or more differences between parameters that are optimized by the initial reward function and by one or more reward functions associated with the one or more prior scenarios. The method also includes modifying, using the at least one processor, the initial reward function based on at least one of the one or more determined differences to generate a new reward function. In addition, the method includes generating, using the at least one processor, a new policy for the current scenario based on the new reward function.

In a second embodiment, an apparatus includes at least one memory configured to store information associated with a current scenario to be evaluated by an ML/AI algorithm, where the information includes an initial reward function associated with the current scenario. The apparatus also includes at least one processor configured to identify one or more policies associated with one or more prior scenarios that are analogous to the current scenario, determine one or more differences between parameters that are optimized by the initial reward function and by one or more reward functions associated with the one or more prior scenarios, modify the initial reward function based on at least one of the one or more determined differences to generate a new reward function, and generate a new policy for the current scenario based on the new reward function.

In a third embodiment, a non-transitory computer readable medium contains instructions that when executed cause at least one processor to obtain information associated with a current scenario to be evaluated by an ML/AI algorithm, where the information includes an initial reward function associated with the current scenario. The medium also contains instructions that when executed cause the at least one processor to identify one or more policies associated with one or more prior scenarios that are analogous to the current scenario. The medium further contains instructions that when executed cause the at least one processor to determine one or more differences between parameters that are optimized by the initial reward function and by one or more reward functions associated with the one or more prior scenarios. The medium also contains instructions that when executed cause the at least one processor to modify the initial reward function based on at least one of the one or more determined differences to generate a new reward function. In addition, the medium contains instructions that when executed cause the at least one processor to generate a new policy for the current scenario based on the new reward function.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example architecture for providing an explicit ethical machine that uses analogous scenarios according to this disclosure;

FIG. 2 illustrates an example device supporting an explicit ethical machine that uses analogous scenarios according to this disclosure;

FIG. 3 illustrates an example use of a single-agent architecture for providing an explicit ethical machine that uses analogous scenarios according to this disclosure;

FIG. 4 illustrates an example use of a multi-agent architecture for providing an explicit ethical machine that uses analogous scenarios according to this disclosure;

FIG. 5 illustrates an example technique for using Inverse Reinforcement Learning in an architecture for providing an explicit ethical machine that uses analogous scenarios according to this disclosure; and

FIG. 6 illustrates an example method for providing an explicit ethical machine that uses analogous scenarios according to this disclosure.

### DETAILED DESCRIPTION

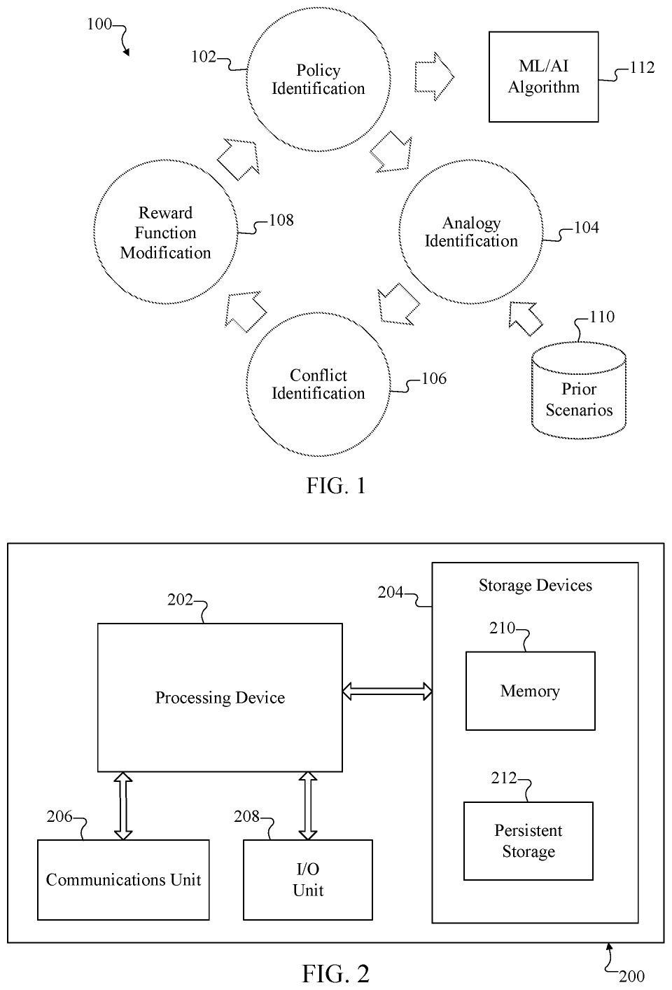

FIGS. 1 through 6, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, with the increasing adoption of autonomous and semi-autonomous decision-making algorithms in various domains, it is common for the algorithms to encounter scenarios with ethical dilemmas. One example of an ethical dilemma is often referred to as the “trolley problem,” which generally considers a hypothetical situation in which a runaway trolley is heading towards multiple people on one track but can be diverted onto a different track occupied by a single person. These and other types of ethical dilemmas can arise in various decision-making algorithms, such as in designing control systems for autonomous vehicles. Unfortunately, complex autonomous and semi-autonomous systems routinely use machine learning (ML) algorithms or other artificial intelligence (AI) algorithms that provide limited transparency to operators, essentially acting as “black boxes.” As a result, system engineers will often design requirements and system behaviors into defined parameters, and these defined parameters are expected to then operate correctly when placed into use.

Current approaches used in autonomous and semi-autonomous systems often rely on closed-world assumptions that encode desired courses of action for given scenarios. However, these approaches are very fragile and often cannot be extended to even slight changes in an environment or scenario, thus making these systems untrustworthy and essentially prone to making catastrophic errors. The U.S. Department of Defense has adopted five key “ethical principles” of artificial intelligence systems that encompass five major areas, which are generally classified as “responsible,” “equitable,” “traceable,” “reliable,” and “governable.” However, implementation of these five principles into practice in the field is currently dependent on amorphous human judgments, which are prone to error and bias. Moreover, it is not always apparent whether a course of action to be taken by an autonomous or semi-autonomous system has any ethical implications.

This disclosure provides various techniques for implementing explicit ethical machines that can satisfy at least some of these types of principles using analogous scenarios to provide operational guardrails. As described in more detail below, these techniques represent operational scenarios using Markov decision processes that encode goal-specific reward functions. During operation, a current scenario can be represented using a Markov decision process that encodes an initial reward function. At least one prior scenario that is analogous to the current scenario can be identified, and at least one policy associated with the analogous scenario(s) can also be identified. One or more policies associated with one or more analogous scenarios can be applied to the current scenario, which involves modifying the initial reward function associated with the current scenario based on the one or more policies associated with the one or more analogous scenarios. This leads to the creation of a new policy for the current scenario, where the new policy includes the modified reward function for the current scenario. The new policy for the current scenario may then be used to identify a course of action to be taken in the current scenario. Interactions with one or more human operators may also occur to support continuous learning of features of ethical decisions. For instance, one or more machine-generated justifications for a selected course of action in a given scenario may be evaluated against one or more human justifications in order to estimate the level of “moral maturity” of the machine.

In this way, prior experiences in the form of analogous prior scenarios can be ingested, such as through the use of statistical techniques, to draw parallels and analogies for application to new (previously-unexamined) scenarios. As a result, these techniques allow for ML/AI algorithms to be designed to learn from other scenarios when attempting to make decisions related to new scenarios for which the algorithms were not previously trained. The analogous prior scenarios thereby act as guardrails for the current scenario and help to ensure that the course of action selected for the current scenario is not catastrophically incorrect. Essentially, this provides a framework that allows ML/AI algorithms to identify and reason about ethics in a consistent and transparent manner. Moreover, these techniques can be used to clearly identify how an autonomous or semi-autonomous system arrives at a given conclusion and selects a specific course of action for a given scenario. This can help to support traceable, reliable, and governable operations of the autonomous or semi-autonomous system. Further, these techniques allow for engineers, designers, operators, and other personnel to gain insights into how autonomy is being used in a system and whether there is over- or under-reliance on autonomy. In addition, transparent, trustworthy, and ethically-explicit operations of autonomous and semi-autonomous systems can help to increase adoption of the systems into various applications.

As a particular example of this functionality, autonomous vehicle control systems may require operation over five billion miles to demonstrate a 95% confidence in their reliability. Using the approaches here, rare events can be simulated, and prior events in analogous scenarios can be used to determine how the autonomous vehicle control systems would respond. Among other things, this allows autonomous vehicle control systems or other autonomous/semi-autonomous systems to self-evaluate and accelerate validation and assurance evaluations. This also allows engineers, designers, operators, or other personnel associated with autonomous vehicle control systems or other autonomous/semi-autonomous systems to forecast the ethical impacts of possible courses of action based on prior scenarios, even if a current scenario might not appear to involve any ethical considerations.

FIG. 1 illustrates an example architecture 100 for providing an explicit ethical machine that uses analogous scenarios according to this disclosure. As shown in FIG. 1, the architecture 100 here includes various operations 102-108 and a database 110 that can be used to train at least one ML/AI algorithm 112 to simultaneously reason about both task-based and ethical decisions. The operations 102-108 here can be performed iteratively, which allows the ML/AI algorithm 112 to be trained iteratively in order to perform increasingly complex reasoning. This ideally allows the ML/AI algorithm 112 to handle more and more complex task-based and ethical decision-making problems.

The operation 102 generally represents a policy identification operation that involves identifying, generating, or otherwise obtaining an initial policy associated with a current scenario to be evaluated by an ML/AI algorithm 112. In some embodiments, the current scenario may be represented using a Markov decision process (MDP), which includes a set of possible states (S), a set of possible actions (A), and a reward function (R) that defines rewards for transitioning between the states due to the actions. The initial policy represents an initial function that specifies the action to be taken when in a specified state. The initial policy is typically based on an initial set of one or more parameters to be optimized as defined by the reward function. The combination of a Markov decision process and a policy identifies the action for each state of the process, and the policy can ideally be chosen to maximize a function of the rewards. In particular embodiments, the Markov decision process representing a current scenario and an initial reward function identifying one or more parameters to be optimized may be obtained from one or more users.

The operation 104 generally represents an analogy identification operation that involves identifying one or more prior scenarios that are analogous in some respect to the initial policy associated with the current scenario to be evaluated by the ML/AI algorithm 112. The prior scenarios may be analogous to the initial policy in terms of their Markov decision processes, their sets of parameters to be optimized, or both. The identification of any analogous prior scenarios may occur in any suitable manner, such as by using a suitable statistical correlation technique. The operation 104 can output suitable information related to the one or more prior scenarios that are analogous to the current scenario.

In this example, the operation 104 can involve use of the database 110, which can store various information about the prior scenarios. The information in the database 110 may include information about actual prior scenarios that have been encountered by the ML/AI algorithm 112 (or another ML/AI algorithm). The information in the database 110 may also or alternatively include information about simulated scenarios, such as scenarios that might be encountered in a given environment. The database 110 may store any suitable information about each prior scenario, such as the prior scenario's Markov decision process, reward function, and other information of the prior scenario's policy. The output of the operation 104 may include each analogous prior scenario's policy or other information contained in the database 110.

The operation 106 generally represents a conflicts identification operation that involves identifying differences (conflicts) between the initial policy associated with the current scenario and the policy associated with each analogous prior scenario. For example, the initial policy associated with the current scenario and the policy associated with an analogous prior scenario may relate to similar problems but include different sets of parameters to be optimized (and thus have different reward functions). The operation 106 here can therefore identify the reasoning used in one or more analogous scenarios that might be applied in the current scenario. The operation 106 can output information identifying that reasoning, such as in the form of an analogous reward function.

In some embodiments, the operation 106 involves the use of Inverse Reinforcement Learning (IRL), which is a process of extracting a reward function based on observed behavior. In other words, the operation 106 may use IRL here to identify a reward function based on the behavior that occurs in one or more analogous prior scenarios. The operation 106 may then generate an analogous reward function for the current scenario to be evaluated. The analogous reward function here may include various parameters to be optimized, including one or more parameters that were not included in the original reward function and/or omitting one or more parameters that were included in the original reward function.

The operation 108 generally represents a reward function modification operation that involves comparing the initial reward function with the analogous reward function to identify any differences. The operation 108 can then generate a new reward function based on the comparison. For example, the operation 108 may determine that one or more specific parameters optimized in the analogous reward function are not included in the original reward function and should be. The operation 108 may therefore generate and output a new reward function that has been updated to include the one or more specific parameters. The new reward function can be used to form an updated policy associated with the current scenario to be evaluated.

At this point, human interaction may optionally occur in order to verify if the updated policy is acceptable. For example, the updated policy may be provided to the ML/AI algorithm 112 for use in identifying a proposed course of action for the current scenario, and one or more humans may evaluate whether the proposed course of action is acceptable. The updated policy may also be stored in the database 110 along with other information about the current scenario, which allows the updated policy to be used with subsequent scenarios. The updated policy may further be fed back through another iteration of the process shown here, which allows for iterative updates of the policy. This may allow for more complex situations to be learned as the number of prior scenarios increases.

Overall, this architecture 100 provides a machine learning framework that is able to iteratively adapt different reward functions based on increasingly complex reasoning, such as by including more or more parameters in the iterations. This may be generally consistent with human moral development, such as is defined by the Kohlberg theory of moral development. The Kohlberg theory generally models moral development as occurring in six stages:
Stage 1—Punishment and Obedience Orientation (obey rules to avoid punishment)
Stage 2—Instrumental-Relativist Orientation (conform to get rewards or earn favors)
Stage 3—Good Boy/Girl Orientation (conform to avoid disapproval of others)
Stage 4—Law and Order Orientation (conform to avoid punishment by authorities)
Stage 5—Social Contract Orientation (conform to maintain communities)
Stage 6—Universal Ethical Principles Orientation (consider how others are affected by decision)
   The first and second stages are often referred to as “pre-conventional,” the third and fourth stages are often referred to as “conventional,” and the fifth and sixth stages are often referred to as “post-conventional.” The ability of the architecture 100 to perform increasingly-complex reasoning supports the ability of the ML/AI algorithm 112 to become more effective at making ethical decisions over time consistent with this type of model (of course, other models may be used to illustrate this principle). By comparing the decisions of the ML/AI algorithm 112 and the bases for those decisions against human justifications, it is possible to evaluate the level of moral maturity of the ML/AI algorithm 112.

Moreover, the architecture 100 here supports the use of analogical reasoning (possibly with heuristics) to identify additional parameters from prior experience, and an ethical justification or explanation of an action selected may be provided. This helps to support the use of transparent, trustworthy, and ethically-explicit operations by the ML/AI algorithm 112. Further, the architecture 100 provides a framework for evaluating the morale reasoning of the ML/AI algorithm 112, rather than merely evaluating the selected actions of the ML/AI algorithm 112. This is useful since the same observable outcome can be manifested from different levels of moral development, such as when the outcome of “do not steal” results from low moral development (to avoid punishment) and high moral development (to adhere to a universal ethical principle). The architecture 100 provides the ability to determine or explain why the ML/AI algorithm 112 chose a selected course of action, rather than merely evaluating whether the ML/AI algorithm 112 chose a “correct” course of action. This can help to reduce or eliminate catastrophic errors by the ML/AI algorithm 112. In addition, the architecture 100 here can be used to train explicit ethical agents that are not completely rule-based, which helps to avoid pitfalls associated with implicit agents. For instance, the explicit ethical agents can be scalable, may not rely on designers to anticipate every possible scenario (therefore helping with risks unforeseen by humans), and can provide concrete explanations of decisions to justify those decisions.

Note that the operations 102-108 described above with reference to FIG. 1 can be implemented in one or more devices in any suitable manner. For example, in some embodiments, the operations 102-108 may be implemented using dedicated hardware or a combination of hardware and software/firmware instructions. Also, in some embodiments, the operations 102-108 can be implemented using hardware or hardware and software/firmware instructions embedded in a larger system, such as a system that uses one or more ML/AI algorithms 112 to perform one or more functions. However, this disclosure is not limited to any particular physical implementation of the operations 102-108.

Although FIG. 1 illustrates one example of an architecture 100 for providing an explicit ethical machine that uses analogous scenarios, various changes may be made to FIG. 1. For example, any suitable number of iterations of the process performed by the architecture 100 may occur. Also, the architecture 100 does not necessarily need to perform all operations 102-108 in each iteration, such as when the architecture 100 may skip the operations 106-108 if no prior scenarios analogous to the current scenario are identified.

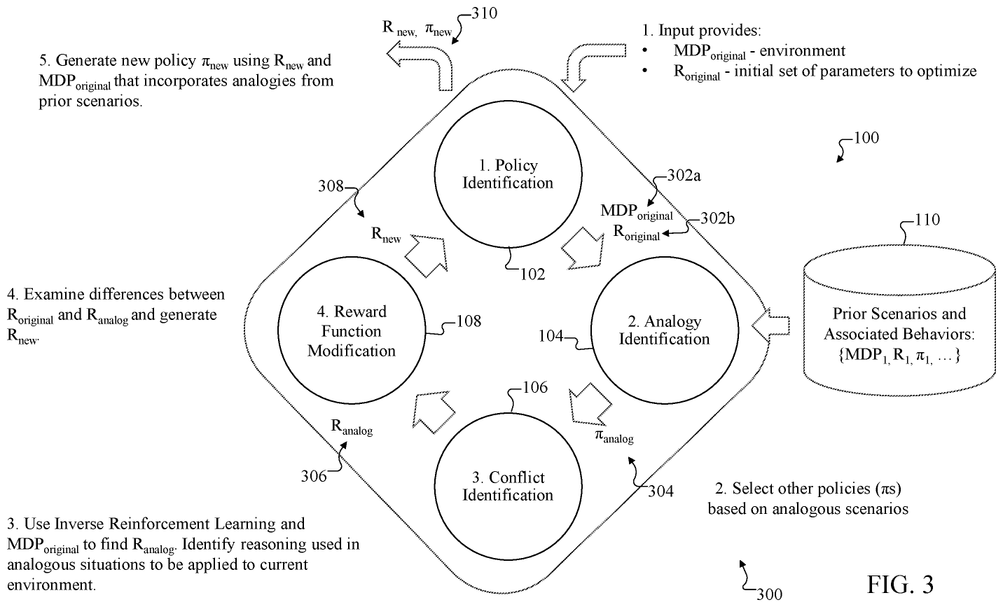

FIG. 2 illustrates an example device 200 supporting an explicit ethical machine that uses analogous scenarios according to this disclosure. One or more instances of the device 200 may, for example, be used to at least partially implement the operations 102-108 shown in FIG. 1. However, the operations 102-108 may be implemented in any other suitable manner. In some embodiments, the device 200 shown in FIG. 2 may form at least part of a computing system, such as a desktop, laptop, server, or tablet computer. However, any other suitable device or devices may be used to perform the operations 102-108.

As shown in FIG. 2, the device 200 denotes a computing device that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network or direct connection. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device 200 does not require local I/O, such as when the device 200 represents a server or other device that can be accessed remotely.

In some embodiments, the instructions executed by the processing device 202 include instructions that implement the operations 102-108 described above. Thus, for example, the instructions executed by the processing device 202 may cause the processing device 202 to obtain an initial policy for a current scenario and identify any prior scenarios that are analogous to the current scenario. The instructions executed by the processing device 202 may also cause the processing device 202 to identify an analogous reward function and generate a new reward function and an updated policy for the current scenario. The updated policy may be provided to the ML/AI algorithm 112 in order to identify a course of action selected by the ML/AI algorithm 112 for the current scenario. The updated policy may also be used in any other suitable manner.

Although FIG. 2 illustrates one example of a device 200 supporting an explicit ethical machine that uses analogous scenarios, various changes may be made to FIG. 2. For example, computing and communication devices and systems come in a wide variety of configurations, and FIG. 2 does not limit this disclosure to any particular computing or communication device or system.

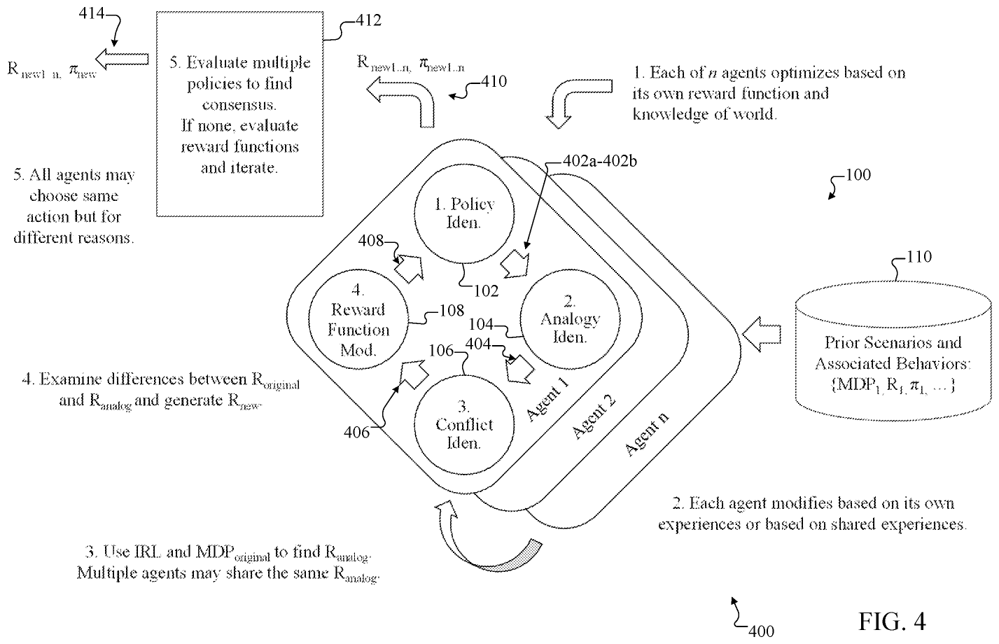

FIG. 3 illustrates an example use of a single-agent architecture 300 for providing an explicit ethical machine that uses analogous scenarios according to this disclosure. The single-agent architecture 300 here uses a single instance of the architecture 100 to support the use of at least one ML/AI algorithm 112. As shown in FIG. 3, input related to a current scenario is provided to the policy identification operation 102 in the single instance of the architecture 100. The input here includes a Markov decision process (MDP_{original}) 302a and an initial set of one or more parameters to optimize, which may be expressed in an original reward function (R_{original}) 302b. The input may be obtained from any suitable source(s), such as a user, and in any suitable manner.

The policy identification operation 102 provides an initial policy containing this information to the analogy identification operation 104, which accesses the database 110 to identify any prior scenarios that are analogous to the current scenario. The analogy identification operation 104 can output one or more analogous policies (π_{analog}) 304, which represent one or more policies associated with one or more analogous prior scenarios. As noted above, the identification of the one or more analogous prior scenarios may occur in any suitable manner, such as via statistical correlation of the current scenario's information with information associated with the prior scenarios.

The conflicts identification operation 106 can identify whether the one or more analogous policies 304 optimize any parameters that are not optimized by the original reward function 302b. The conflicts identification operation 106 can also or alternatively identify whether the one or more analogous policies 304 do not optimize any parameters that are optimized by the original reward function 302b. In some embodiments, the conflicts identification operation 106 may perform IRL using the Markov decision process 302a and the one or more analogous policies 304 to identify any parameters associated with the analogous prior scenarios that are or are not optimized by the original reward function 302b (or vice versa). The results can be output from the conflicts identification operation 106 as an analogous reward function (R_{analog}) 306.

The reward function modification operation 108 examines the differences between the original reward function 302b and the analogous reward function 306. Based on this, the reward function modification operation 108 determines one or more parameters from the analogous prior scenarios that can be inserted into the original reward function 302b for optimization, and/or the reward function modification operation 108 determines one or more parameters in the original reward function 302b that can be removed from the original reward function 302b. This helps to analogize the current scenario to the prior scenario(s) by modifying the reward function for the current scenario. The reward function modification operation 108 can update the original reward function 302b in this manner to produce a new reward function (R_{new}) 308. The policy identification operation 102 may combine the Markov decision process 302a with the new reward function 308 to produce a new policy (π_{new}) 310, which (ideally) represents the initial policy as modified by incorporating one or more analogies from one or more prior scenarios.

The new policy 310 may be used in any suitable manner. For example, the new policy 310 may be provided from the policy identification operation 102 to the analogy identification operation 104 for another iteration of the process (where R_{original} in the next iteration represents R_{new} from the prior iteration). The new policy 310 may be stored in the database 110 for use in finding analogies for other input policies. The new policy 310 may be provided to an ML/AI algorithm 112 so that the ML/AI algorithm 112 can identify a proposed course of action for the current scenario. In some cases, the proposed course of action may be evaluated by comparison with human justifications to determine whether the new policy 310 allows the correct course of action to be selected for the right reason(s).

The single-agent approach shown in FIG. 3 may be used in any number of applications, such as the following examples. Note that the examples below are for illustration only and do not limit the scope of this disclosure to the particular examples or types of examples described below.

In one application, an ML/AI algorithm 112 may be trained to select which of multiple patients should receive dialysis. The architecture 300 may receive as input 302a-302b an indication of the number of dialysis machines available in a given area, a list of patients needing to receive dialysis in the given area (including demographic information), and an indication that the selection should be optimized based on patient age. Using statistical correlation or other techniques, the architecture 300 may determine that selecting patients for dialysis has similar characteristics as selecting patients for kidney transplants and that a prior scenario has been defined related to selecting patients for kidney transplants. The policy related to selecting patients for kidney transplants may be chosen as an analogous policy 304, and the architecture 300 may analyze the analogous policy 304 and determine that the analogous policy 304 includes two parameters (smoking and drug use) that are not included in and optimized by the original reward function 302b. These parameters may therefore be included in an analogous reward function 306, and other or additional parameters may be included or some existing parameters from the original reward function 302b may be excluded from the analogous reward function 306. The architecture 300 may then generate a new reward function 308 based on the original reward function 302b and the analogous reward function 306, such as when the new reward function 308 includes one or both of the parameters (smoking and drug use) from the analogous policy 304. The new reward function 308 can be used to generate a new policy 310, and the ML/AI algorithm 112 can apply the new policy 310 to the problem of selecting which of multiple patients should receive dialysis. The ML/AI algorithm 112 can also provide an explanation of why the selected patients were chosen for dialysis, such as by outputting information indicating the analogous policy 304 was selected and two parameters from the analogous policy 304 were included in the new policy 310.

In another application, an ML/AI algorithm 112 may be trained to determine where hospitals are to be built in a specified region. The architecture 300 may receive as input 302-302b an indication of the number of hospitals to be built, demographics in the specified region, and an indication that the determination should be optimized based on population size. Using statistical correlation or other techniques, the architecture 300 may determine that identifying where hospitals are to be built has similar characteristics as identifying where schools are to be built and that a prior scenario has been defined related to identifying where schools are to be built. The policy related to identifying where schools are to be built may be chosen as an analogous policy 304, and the architecture 300 may analyze the analogous policy 304 and determine that the analogous policy 304 includes one parameter (connectivity to other towns) that is not included in and optimized by the original reward function 302b. This parameter may therefore be included in an analogous reward function 306, and other or additional parameters may be included or some existing parameters from the original reward function 302b may be excluded from the analogous reward function 306. The architecture 300 may then generate a new reward function 308 based on the original reward function 302b and the analogous reward function 306, such as when the new reward function 308 includes the new parameter from the analogous policy 304. The new reward function 308 can be used to generate a new policy 310, and the ML/AI algorithm 112 can apply the new policy 310 to the problem of identifying where hospitals are to be built. The ML/AI algorithm 112 can also provide an explanation of why the identified locations for the hospitals were chosen, such as by outputting information indicating the analogous policy 304 was selected and the parameter from the analogous policy 304 was included in the new policy 310.

FIG. 4 illustrates an example use of a multi-agent architecture 400 for providing an explicit ethical machine that uses analogous scenarios according to this disclosure. The multi-agent architecture 400 here uses multiple instances of the architecture 100 to support the use of at least one ML/AI algorithm 112, although the multiple instances of the architecture 100 can share the same database 110 (note that this is not required, though). The different instances of the architecture 100 may have different biases or preferences in terms of how tasks are to be performed. As shown in FIG. 4, input related to a current scenario is provided to each policy identification operation 102 in each instance of the architecture 100. The input here includes a Markov decision process 402a and an initial set of one or more parameters to optimize, which may be expressed in an original reward function 402b. The input may be obtained from any suitable source(s), such as a user, and in any suitable manner.

Each policy identification operation 102 provides this information to an associated analogy identification operation 104, which accesses the database 110 to identify any prior scenarios that are analogous to the current scenario. Note that the prior scenarios accessed by each analogy identification operation 104 may be related only to that specific instance of the architecture 100, or the prior scenarios may be shared across multiple instances of the architecture 100. Each analogy identification operation 104 can output one or more analogous policies 404, which represent one or more policies associated with one or more analogous prior scenarios. As noted above, the identification of the one or more analogous prior scenarios may occur in any suitable manner, such as via statistical correlation of the current scenario's information with information associated with the prior scenarios.

Each conflicts identification operation 106 can identify whether its one or more analogous policies 404 optimize any parameters that are not optimized by its associated original reward function 402b. Each conflicts identification operation 106 can also or alternatively identify whether its one or more analogous policies 404 do not optimize any parameters that are optimized by the original reward function 402b. In some embodiments, each conflicts identification operation 106 may perform IRL using the Markov decision process 402a and its one or more analogous policies 404 to identify any parameters associated with its analogous prior scenarios that are or are not optimized by its original reward function 402b (or vice versa). The results can be output from each conflicts identification operation 106 as an analogous reward function 406. Note that each conflicts identification operation 106 may output its own analogous reward function 406, or multiple conflicts identification operations 106 may share a common analogous reward function 406.

Each reward function modification operation 108 examines the differences between its original reward function 402b and its analogous reward function 406. Based on this, each reward function modification operation 108 determines one or more parameters from its analogous prior scenarios that can be inserted into its original reward function 402b for optimization, and/or each reward function modification operation 108 determines one or more parameters in its original reward function 402b that can be removed from its original reward function 402b. This helps to analogize the current scenario to the prior scenario(s) by modifying each reward function for the current scenario. Each reward function modification operation 108 can update its original reward function 402b in this manner to produce a new reward function 408. Each policy identification operation 102 may combine the Markov decision process 402a with its new reward function 408 to produce a new policy (anew) 410, which (ideally) represents the initial policy as modified by incorporating one or more analogies from one or more prior scenarios.

The new policies 410 from the multiple instances of the architecture 100 can be provided to an evaluation operation 412, which evaluates the new policies 410 to determine if the multiple instances of the architecture 100 come to a consensus in terms of how courses of action are selected. Consensus here may be defined as all instances of the architecture 100 generating policies 410 that identify the same courses of action, a majority or other specified number/percentage of the instances of the architecture 100 generating policies 410 that identify the same course of actions, or any other suitable criteria. Note that multiple instances of the architecture 100 may be used to select the same course of action, but possibly for different reasons. If no consensus is obtained, the evaluation operation 412 may adjust one or more of the original reward functions 402b used by one or more instances of the architecture 100, and the process can be repeated. If consensus is obtained, the new policies 410 may be used as a final set of policies 414 for the ML/AI algorithm(s) 112.

The new policies 414 may be used in any suitable manner. For example, the new policies 414 may be provided from the policy identification operations 102 to the analogy identification operations 104 for another iteration of the process. The new policies 414 may be stored in the database 110 for use in finding analogies for other input policies. The new policies 414 may be provided to the ML/AI algorithm(s) 112 so that the ML/AI algorithm(s) 112 can identify proposed courses of action for the current scenario. In some cases, the proposed courses of action may be evaluated by comparison with human justifications to determine whether the new policies 414 allow the correct course of action to be selected for the right reason(s).

The multi-agent approach shown in FIG. 4 may be used in any number of applications, such as the following example. Note that the example below is for illustration only and does not limit the scope of this disclosure to the particular example or type of example described below.

In one application, at least one ML/AI algorithm 112 may be trained to operate a missile defense system and select incoming missiles to be engaged and destroyed by the missile defense system. Different locations may be targeted by incoming missiles, and each location may have its own instance of the architecture 100. The architecture 400 may receive as input 402a-402b an indication of the number of incoming missiles and an indication that the selection of incoming missiles to be engaged should be optimized to protect civilian populations. Using statistical correlation or other techniques, each instance of the architecture 100 may determine that another prior scenario has been defined related to the current scenario. The policy related to that prior scenario may be chosen as an analogous policy 404, and each instance of the architecture 100 may analyze the analogous policy 404 and determine that the analogous policy 404 includes one or more parameters that are not included in its original reward function 402b. These parameters may be included in each analogous reward function 406, and other or additional parameters may be included or some existing parameters from each original reward function 402b may be excluded from the associated analogous reward function 406. Each instance of the architecture 100 may then generate new a reward function 408 based on its original reward function 402b, the new reward functions 408 can be used to generate new policies 410, and the new policies 410 may be compared to look for consensus. If consensus is obtained, the ML/AI algorithm(s) 112 can apply the new policies 410 as the final set of policies 414 to the problem of selecting which incoming missiles to engage. If consensus is not obtained, the evaluation operation 412 can adjust one or more original reward functions 402b and repeat the process until consensus is obtained (or until some other specified criterion or criteria are met). The ML/AI algorithm(s) 112 can also provide an explanation of why the selected incoming missiles were selected for engagement, such as by outputting suitable information explaining the process.

Although FIGS. 3 and 4 illustrate examples of uses of single-agent and multi-agent architectures 300, 400 for providing explicit ethical machines that use analogous scenarios, various changes may be made to FIGS. 3 and 4. For example, there may be multiple databases 110 used in either architecture 300 or 400, and/or the one or more databases 110 may be local to or remote from the device(s) implementing the instance(s) of the architecture 100. Also, any suitable number of instances of the architecture 100 may be used in a multi-agent system, and the results from the instances of the architecture 100 may be combined or otherwise used in any other suitable manner.

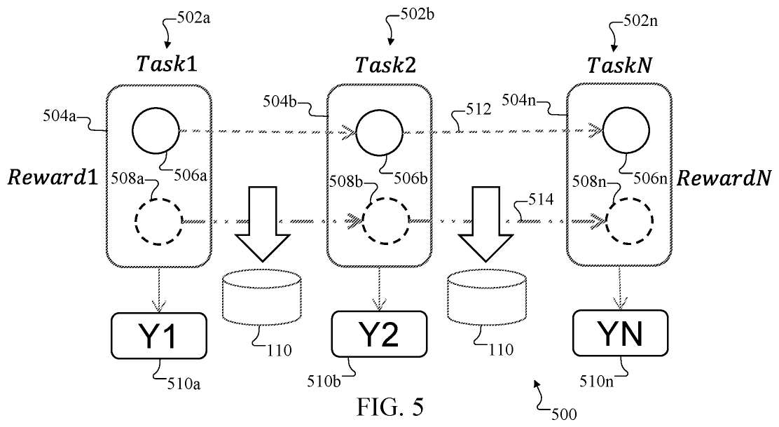

FIG. 5 illustrates an example technique 500 for using Inverse Reinforcement Learning in an architecture for providing an explicit ethical machine that uses analogous scenarios according to this disclosure. The technique 500 shown in FIG. 5 may, for example, be used by the operation 106 to refine reward functions based on analogous scenarios. Note, however, that the operation 106 may be implemented in any other suitable manner.

As shown in FIG. 5, the technique 500 involves a sequence of tasks 502a-502n that occur over time, where the task 502a occurs first and the other tasks 502b-502n follow sequentially. Each of the tasks 502a-502n is respectively associated with a version of a reward function 504a-504n, where the reward functions 504a-504n may represent a common reward function changing over time.

Each version of the reward function 504a-504n here respectively includes or is otherwise associated with a task-agnostic portion 506a-506n and a task-dependent portion 508a-508n. The task-agnostic portions 506a-506n of the reward functions 504a-504n can be used to help define a reward system that enforces ethical boundaries regardless of the task being performed. The task-dependent portions 508a-508n of the reward functions 504a-504n can be used to help define a reward system that drives contextual behaviors of the reward system. Each reward function 504a-504n can be used here to generate a result 510a-510n, which represents application of the reward function 504a-504n to data associated with the respective task 502a-502n. The task-agnostic portion 506a-506n and the task-dependent portion 508a-508n of each reward function 504a-504n may be used to produce the associated result 510a-510n.

Lines 512 here define refinements in ethical behaviors that may occur to the task-agnostic portions 506a-506n over time. This allows, for example, a progressive inheritance and refinement of the ethical component of reward in order to achieve higher levels of moral development (such as moving up in the stages of the Kohlberg model). Lines 514 here define analogical reasoning and transfer learning that may occur to the task-dependent portions 508a-508n over time. This allows, for instance, analogies with prior scenarios to be used to facilitate learning over time, which can occur in the manner described above using the database 110. The ability to analogize with prior scenarios can help to increase learning and reduce training requirements of the ML/AI algorithm(s) 112. Here, a Bayesian formulation can provide a theoretically-sound framework of learning and acting under uncertainties and can enable trade-off analysis over conflicting moral norms and rewards.

Although FIG. 5 illustrates one example of a technique 500 for using Inverse Reinforcement Learning in an architecture for providing an explicit ethical machine that uses analogous scenarios, various changes may be made to FIG. 5. For example, a reward function may evolve over time in various ways based on changes to its task-agnostic portion and/or its task-dependent portion.

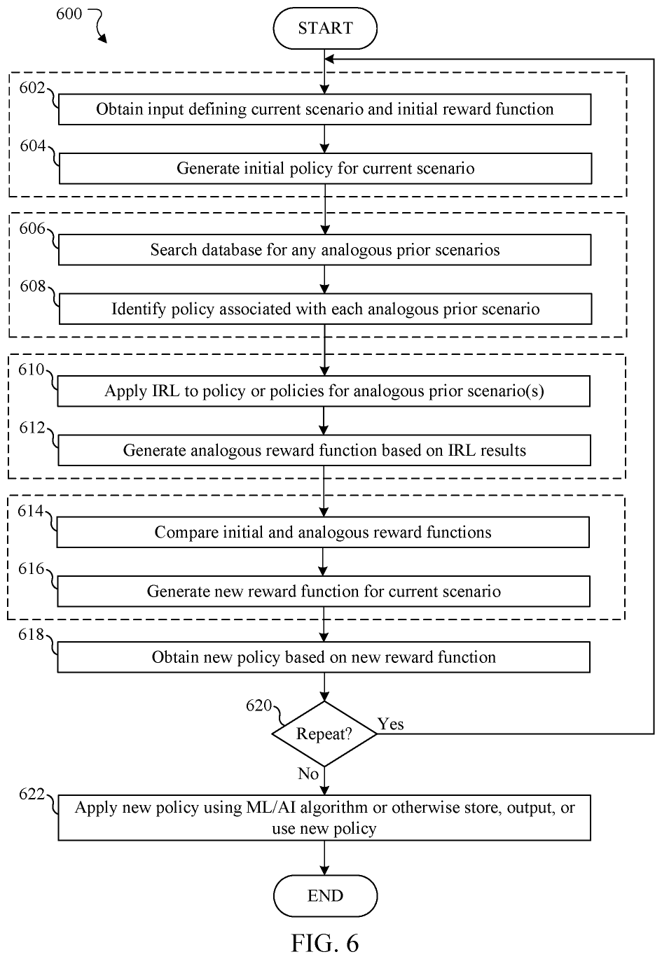

FIG. 6 illustrates an example method 600 for providing an explicit ethical machine that uses analogous scenarios according to this disclosure. For ease of explanation, the method 600 is described as being performed by the architecture 100, which may be implemented using at least one device 200 of FIG. 2. However, the method 600 may be performed by any suitable device(s) and in any suitable system(s).

As shown in FIG. 6, input information defining a current scenario and an initial reward function is obtained at step 602 and used to generate an initial policy for the current scenario at step 604. This may include, for example, the processing device 202 performing the policy identification operation 102 to receive information defining a Markov decision process and an original reward function from a user or other source(s). This may also include the processing device 202 performing the policy identification operation 102 to use the Markov decision process and the original reward function as the initial policy for the current scenario or to produce the initial policy for the current scenario. The original reward function may identify one or more parameters to be optimized when selecting a course of action for the current scenario.

A database is searched for any prior scenarios that are analogous to the current scenario at step 606, and an analogous policy associated with each analogous prior scenario is identified at step 608. This may include, for example, the processing device 202 performing the analogy identification operation 104 to search the database 110 for any prior scenarios that are analogous to the current scenario. In some cases, analogous may be determined statistically, such as based on similarities of the current and prior scenarios' Markov decision processes and reward functions. This may also include the processing device 202 performing the analogy identification operation 104 to extract policy information associated with each identified analogous prior scenario from the database 110 and to use the policy information as one or more analogous policies.

Inverse Reinforcement Learning is applied to the policy or policies associated with one or more analogous prior scenarios at step 610, and an analogous reward function is generated based on the IRL results at step 612. This may include, for example, the processing device 202 performing the conflicts identification operation 106, which can use the Markov decision process for the current scenario and information about the analogous policies, to identify the analogous reward function. The analogous reward function may include one or more parameters that are not included in the original reward function, and/or the analogous reward function may omit one or more parameters that are included in the original reward function.

The initial and analogous reward functions are compared at step 614, and a new reward function for the current scenario is generated at step 616. This may include, for example, the processing device 202 performing the reward function modification operation 108 to identify the differences between the original and analogous reward functions in order to identify (i) one or more parameters in the analogous reward function that are not included in the original reward function and/or (ii) one or more parameters in the original reward function that are not included in the analogous reward function. This may also include the processing device 202 performing the reward function modification operation 108 to generate a new reward function, which can represent the original reward function as modified to (i) include at least one parameter from the analogous reward function and/or (ii) exclude at least one parameter from the original reward function.

A new policy based on the new reward function is obtained at step 618. This may include, for example, the processing device 202 performing the policy identification operation 102 to use the Markov decision process for the current scenario and the new reward function for the current scenario as a new policy for the current scenario. At this point, a determination may optionally be made whether to repeat the process at step 620. In some cases, the decision at step 620 is used when there are multiple agents (multiple instances of the architecture 100) each performing steps 602-618 and the resulting policies from the multiple agents do not conform. In other cases, the decision at step 620 is used to determine whether the new policy is to be subjected to another iteration of the process. This may allow, for instance, more and more parameters to be added to the policies and considered during reasoning. For whatever reason, if repetition is desired, the process returns to step 602 (or some other step) to repeat one or more of the operations.

The new policy may be applied using an ML/AI algorithm or otherwise stored, output, or used in some manner at step 622. This may include, for example, the processing device 202 providing the new policy to an ML/AI algorithm 112, which may be executed by the same processing device 202 or a different processing device. This may also include the ML/AI algorithm 112 using the new policy to identify a selected course of action to occur as a result of the current scenario. Note, however, that the new policy may be stored, output, or used in any other suitable manner, including in the various ways discussed above.

Although FIG. 6 illustrates one example of a method 600 for providing an explicit ethical machine that uses analogous scenarios, various changes may be made to FIG. 6. For example, while shown as a series of steps, various steps in FIG. 6 may overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining, using at least one processor, information associated with a current scenario to be evaluated by a machine learning/artificial intelligence (ML/AI) algorithm, the information comprising an initial reward function associated with the current scenario;
identifying, using the at least one processor, one or more policies associated with one or more prior scenarios that are analogous to the current scenario;
determining, using the at least one processor, one or more differences between parameters that are optimized by the initial reward function and by one or more reward functions associated with the one or more prior scenarios;
modifying, using the at least one processor, the initial reward function based on at least one of the one or more determined differences to generate a new reward function; and
generating, using the at least one processor, a new policy for the current scenario based on the new reward function.

2. The method of claim 1, further comprising:
applying the new policy to the current scenario using the ML/AI algorithm in order to determine a selected course of action for the current scenario.

3. The method of claim 1, further comprising:
repeating at least some of the obtaining, identifying, determining, modifying, and generating operations using the new reward function as the initial reward function.

4. The method of claim 1, wherein:
the information associated with the current scenario comprises a first Markov decision process; and
a database stores one or more second Markov decision processes associated with the one or more prior scenarios.

5. The method of claim 1, wherein determining the one or more differences between the parameters that are optimized comprises using Inverse Reinforcement Learning to identify reasoning used in the one or more prior scenarios to be applied to the current scenario.

6. The method of claim 1, wherein:
the obtaining, identifying, determining, modifying, and generating operations are performed using multiple agents; and
the method further comprises:
comparing the new policies generated by the multiple agents for conformance; and
in response to the new policies generated by the multiple agents not conforming, modifying the initial reward function used by at least one of the multiple agents and repeating at least some of the obtaining, identifying, determining, modifying, and generating operations.

7. The method of claim 1, wherein each of the initial reward function and the new reward function comprises:
a task-agnostic portion configured to enforce one or more ethical boundaries regardless of task; and
a task-dependent portion configured to drive contextual behavior of the associated reward function.

8. An apparatus comprising:
at least one memory configured to store information associated with a current scenario to be evaluated by a machine learning/artificial intelligence (ML/AI) algorithm, the information comprising an initial reward function associated with the current scenario; and
at least one processor configured to:
identify one or more policies associated with one or more prior scenarios that are analogous to the current scenario;
determine one or more differences between parameters that are optimized by the initial reward function and by one or more reward functions associated with the one or more prior scenarios;
modify the initial reward function based on at least one of the one or more determined differences to generate a new reward function; and
generate a new policy for the current scenario based on the new reward function.

9. The apparatus of claim 8, wherein the at least one processor is further configured to apply the new policy to the current scenario using the ML/AI algorithm in order to determine a selected course of action for the current scenario.

10. The apparatus of claim 8, wherein the at least one processor is further configured to use the new reward function as the initial reward function and repeat at least some of the identify, determine, modify, and generate operations.

11. The apparatus of claim 8, wherein:
the information associated with the current scenario comprises a first Markov decision process; and
the at least one processor is configured to access a database that is configured to store one or more second Markov decision processes associated with the one or more prior scenarios.

12. The apparatus of claim 8, wherein, to determine the one or more differences between the parameters that are optimized, the at least one processor is configured to use Inverse Reinforcement Learning to identify reasoning used in the one or more prior scenarios to be applied to the current scenario.

13. The apparatus of claim 8, wherein the at least one processor is further configured to:
perform the identify, determine, modify, and generate operations using multiple agents;
compare the new policies generated by the multiple agents for conformance; and
in response to the new policies generated by the multiple agents not conforming, modify the initial reward function used by at least one of the multiple agents and repeating at least some of the obtaining, identifying, determining, modifying, and generating operations.

14. The apparatus of claim 8, wherein each of the initial reward function and the new reward function comprises:
a task-agnostic portion configured to enforce one or more ethical boundaries regardless of task; and
a task-dependent portion configured to drive contextual behavior of the associated reward function.

15. A non-transitory computer readable medium containing instructions that when executed cause at least one processor to:
obtain information associated with a current scenario to be evaluated by a machine learning/artificial intelligence (ML/AI) algorithm, the information comprising an initial reward function associated with the current scenario;
identify one or more policies associated with one or more prior scenarios that are analogous to the current scenario;
determine one or more differences between parameters that are optimized by the initial reward function and by one or more reward functions associated with the one or more prior scenarios;
modify the initial reward function based on at least one of the one or more determined differences to generate a new reward function; and
generate a new policy for the current scenario based on the new reward function.

16. The non-transitory computer readable medium of claim 15, further containing instructions that when executed cause the at least one processor to:
apply the new policy to the current scenario using the ML/AI algorithm in order to determine a selected course of action for the current scenario.

17. The non-transitory computer readable medium of claim 15, further containing instructions that when executed cause the at least one processor to:
use the new reward function as the initial reward function and repeat at least some of the obtain, identify, determine, modify, and generate operations.

18. The non-transitory computer readable medium of claim 15, wherein:
the information associated with the current scenario comprises a first Markov decision process; and
the instructions when executed cause the at least one processor to access a database that is configured to store one or more second Markov decision processes associated with the one or more prior scenarios.

19. The non-transitory computer readable medium of claim 15, wherein the instructions that when executed cause the at least one processor to determine the one or more differences between the parameters that are optimized comprise:
instructions that when executed cause the at least one processor to use Inverse Reinforcement Learning to identify reasoning used in the one or more prior scenarios to be applied to the current scenario.

20. The non-transitory computer readable medium of claim 15, further containing instructions that when executed cause the at least one processor to:
perform the obtain, identify, determine, modify, and generate operations using multiple agents;
compare the new policies generated by the multiple agents for conformance; and
in response to the new policies generated by the multiple agents not conforming, modify the initial reward function used by at least one of the multiple agents and repeating at least some of the obtaining, identifying, determining, modifying, and generating operations.
